(19) United States
(12) Patent Application Publication
(10) Pub. No.: US 2017/0073852 A1
(43) Pub. Date: Mar. 16, 2017

(54) METHOD FOR MANUFACTURING BLEND YARN WITH BAMBOO FIBER

(71) Applicants: Naganori SAGAWA, Kyoto (JP); BAMBOO GLOBAL Inc., Fukui (JP)

(72) Inventors: Yukimi UNO, Fukui (JP); Naganori SAGAWA, Kyoto (JP)

(73) Assignees: BAMBOO GLOBAL Inc., Fukui (JP); Naganori SAGAWA, Kyoto (JP)

(21) Appl. No.: 15/267,200

(22) Filed: Sep. 16, 2016

(30) Foreign Application Priority Data
Sep. 16, 2015 (JP) 2015-182801

(51) Int. Cl. D02G 3/04; B05D 1/18

(52) U.S. Cl. CPC D02G 3/04; B05D 1/18; B05D 2256/00

(57) ABSTRACT

Bamboo is immersed in alkali solution. The bamboo is took out from the alkali solution, and dried. Bamboo fiber is obtained from the dried bamboo. A heat and pressure treatment is performed over the obtained bamboo fiber. The treated bamboo fiber is mixed and spun with second fiber to form blend yarn.

Priority is claimed on Japanese Patent Application No. 2015-182801 filed on Sep. 16, 2015, the content of which is incorporated herein by reference.

### TECHNICAL FIELD

The present invention is related to a method for manufacturing blend yarn with bamboo fiber.

### BACKGROUND ART

Bamboo fiber has excellent functions, such as antibacterial, antioxidation, deodorant, soundproof, and the like. Bamboo, which is a raw material of the bamboo fiber, can be obtained with low-cost, because it is widely distributed in warm and wet regions, and grows very quickly.

JP 2005-307413 A discloses a fiber product manufactured by mixing and spinning bamboo fiber with other cellulose fiber.

JP 2007-277746 A discloses a fiber product where a cellulase treatment is performed over bamboo fiber. This enables to restrain prickle sensation caused by the bamboo fiber.

### SUMMARY OF INVENTION

### Technical Problem

The cellulase treatment harms the excellent functions of the bamboo fiber. Also, the product is expensive because mass production is very hard.

The present invention aims to solve such problems.

### Solution to Problem

A method according to the present invention is for manufacturing blend yarn with bamboo fiber. The method includes: immersing bamboo in alkali solution; drying the bamboo took out from the alkali solution; obtaining bamboo fiber from the dried bamboo; performing a heat and pressure treatment over the obtained bamboo fiber; and mixing and spinning the treated bamboo fiber with second fiber to form blend yarn.

The term “bamboo” is intended to mean any plants belonging to Bambusoideae. It may include Bambuseae, Arundinarieae, Olyreae and the like. Phyllostachys bambusoides, Phyllostachys nigra, Phyllostachys edulis, Neosinocalamus affinis, or the like is preferable because they have high toughness and flexibility. Also, the bamboo is preferable within the first year of growing, i.e., logged before 12 months pass after a bamboo shoot becomes bamboo. More preferably, the age of the bamboo is between 2 and 7 months, because it has excellent fiber strength and easy processing. Also, this enables to log new bamboos every year in order to manufacture bamboo fiber.

Before the immersing, bamboo joints may be eliminated from the bamboo. Removal of the bamboo joints, which are very hard, makes it easier to get the bamboo fiber from the bamboo.

Preferably, bamboo surfaces are not eliminated from the bamboo. Residual bamboo fibers derived from the bamboo surfaces, which causes high antibacterial, increases antibacterial of the blend yarn.

Bamboo may be cut to a predetermined length. This increases uniformity of lengths of the bamboo fibers.

The alkali solution is liquid with a pH over 7. It may include sodium hydroxide aqueous solution, ammonia water, sodium bicarbonate liquid, and the like. Immersing the bamboo in the alkali solution makes binder materials, such as lignin, dissolved. This facilitates obtaining the bamboo fiber from the bamboo. Also, this softens the bamboo fiber, especially derived from the bamboo surface.

Preferably, pH of the alkali solution is 10 or more. higher pH promotes more dissolution of the binder. In the case of sodium hydroxide aqueous solution, its concentration is preferably over 1 weight %.

However, too high pH causes damage of the bamboo fiber. Thus, the pH of the alkali solution is preferably 12 or less, and more preferably 11 or less. In the case of sodium hydroxide aqueous solution, its concentration is preferably under 6 weight %, and more preferably under 3 weight %.

The immersing is performed for a sufficient period to make the alkali solution to soak into the bamboo and to dissolve the binder. A preferable duration depends on a thickness of the bamboo. Generally, it may be between 24 and 48 hours, or substantially 36 hours.

Preferably, the bamboo is not washed after took out from the alkali solution. This eliminates problems of industrial effluent polluted with the alkali solution.

The obtaining of the bamboo fiber is performed by dividing the bamboo into the bamboo fibers. The bamboo may be recarded using a recarding machine, and/or defibrated using a defibrating machine.

The heat and pressure treatment is for applying high temperature and high pressure objects, i.e., bamboo fiber. It may include dry distillation treatment, steam explosion treatment, and the like. This removes impurities, such as oil, water, worms, and the like. Residue of the alkali solution, such as sodium hydroxide, is also removed. Lignin is changed to polyphenol, which strengthens antioxidative effect. Also, increasing porosity notably reinforces adsorption of odor, adhesion of floating materials such as formaldehyde or the like, antifungal effect, and the like. Also, combining the heat and pressure treatment with the immersing treatment makes the bamboo fiber, especially derived from the bamboo surface, further soft to restrain prickle sensation.

The dry distillation treatment is for heating objects inside a hermetic vessel such as a pot. This causes pyrolysis without combustion.

The steam explosion treatment is for holding objects under hyperbaric environment, and then suddenly reducing the pressure. This causes breaking the objects in pieces.

Preferable maximum pressure achieved in the heat and pressure treatment is between 5 and 6 atmospheric pressures, i.e., more than about 5,000 hPa (hectopascal) and less than about 6,000 hPa.

Preferable maximum temperature achieved in the heat and pressure treatment is between 140 and 200° C., and more preferable is between 150 and 160° C.

Preferable duration of keeping the maximum pressure and the maximum temperature is between 3 and 10 minutes.

Before the mixing and spinning, the bamboo fiber may be preprocessed, such as screening, drying, or the like. For example, bamboo fibers with lengths between about 15 and about 70 mm and average diameters of 0.2 mm or smaller, preferably between about 0.07 and about 0.1 mm, are extracted from the obtained bamboo fibers. longer and/or thicker bamboo fiber causes higher content rate in the blend yarn, which enhances functions derived from bamboo. Uniformity of lengths and/or thickness of the bamboo fibers promotes entanglement with the second fibers, which facilitates the mixing and spinning. Almost the same lengths of the bamboo fiber as that of the second fiber enables uniform mixing and spinning.

The second fiber may be any fiber except bamboo fiber. It may be derived from plant such as cotton or flax, animal such as sheep or silkworm, or any other sources. Also, it may be natural fiber such as cotton or silk, or artificial fiber such as nylon or carbon fiber.

Before the mixing and spinning, the second fiber may be preprocessed, such as mixing and blowing, cutting, or the like. For example, the second fibers may be cut to have about 40 mm lengths.

The bamboo fiber and the second fiber preferably have almost the same lengths. This enables uniform mixing and spinning

The mixing and spinning may include a mixing step, a carding step, a drawing step, a roving step, a fine spinning step, a winding step, and the like.

The mixing, or blending, step is for mixing the bamboo fiber and the second fiber. Changing a mixing ratio of the bamboo fiber to the second fiber enables the blend yarn to have various properties.

The carding step is for combing the fiber to form a sliver. This enables to uniform directions of the fibers, to remove dust, short fibers, and the like.

The drawing step is for drawing the slivers to form a drawn sliver. This produces uniformity of thickness of the slivers, and removal of short fibers. The drawing step may be performed repeatedly, i.e., applied to the drawn slivers.

The roving step is for drafting and twisting the sliver such as the drawn sliver, to form rove. This reduces the thickness of the sliver.

The fine spinning step is for further drafting and twisting the sliver or rove, to form yarn.

The winding step is for rewinding the yarn to form a large package. This enables to remove neps, dust, yarn unevenness, or the like.

### Advantageous Effects of Invention

The present invention enables to manufacture blend yarn with bamboo fiber with low-cost, while keeping the excellent properties of the bamboo fiber. Products using the blend yarn inherits excellent functions from bamboo, such as high strength, antibacterial effect, antioxidative effect, deodorant effect, and soundproof effect, with no problems of texture and dyeability.

### BRIEF DESCRIPTION OF DRAWINGS

Referring to the accompanying drawings, embodiments will be described in detail. the embodiments and the drawings are provided only for more complete understanding of the present invention. They are not intended to limit the present invention in any meanings.

FIG. 1 shows an example of steps for manufacturing bamboo fiber.

FIG. 2 shows an example of steps for manufacturing blend yarn.

FIG. 3A and 3B show an example of cotton fiber;

FIG. 4 shows an example of a sliver;

FIG. 5A and 5B show an example of slivers and a drawn sliver; and

FIG. 6 shows an example of a rove wound around a bobbin.

### EMBODIMENTS

Manufacturing Bamboo fiber

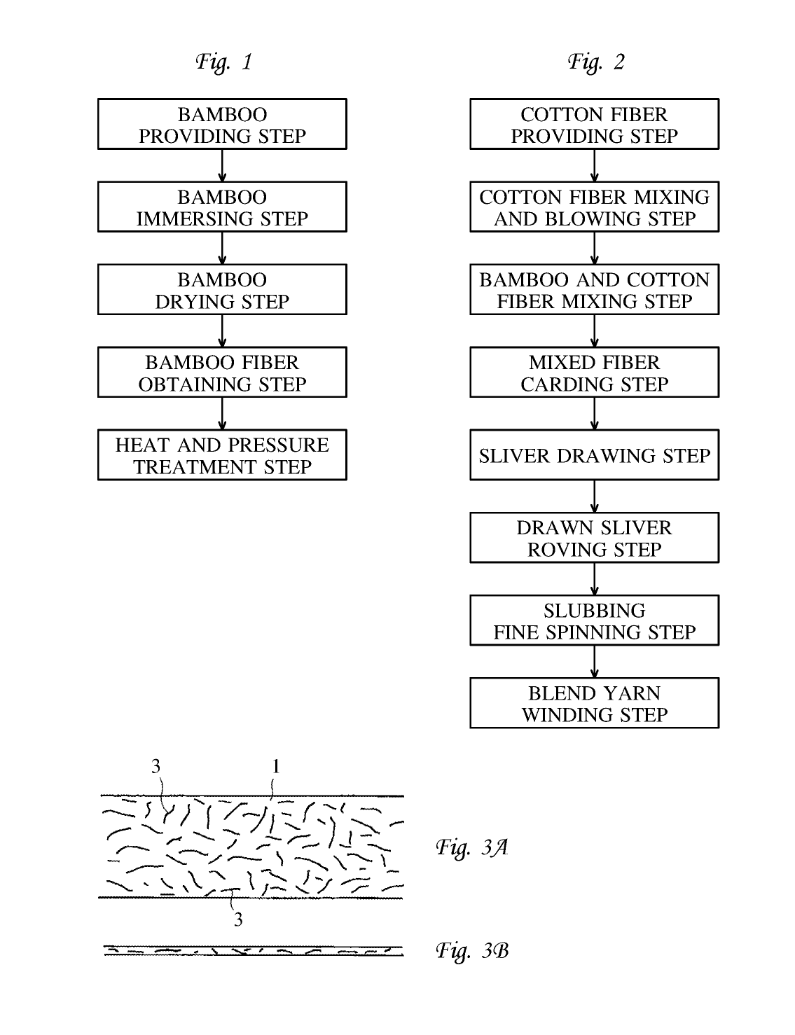

As shown in FIG. 1, Bamboo is firstly provided, for example, by logging bamboo within the first year of growing. And, bamboo splitting machine is used to split the provided bamboo into 4 to 6 pieces. Then, bamboo joints are eliminated from the split bamboo pieces. It should be noted that bamboo surfaces are not eliminated, in contrast to conventional methods. This enables blend yarn to inherit excellent properties, such as antibacterial, from the bamboo surface.

Next, the bamboo pieces are immersed in 1 to 6%, preferably 1 to 3%, sodium hydroxide aqueous solution. They are left as they are for about 36 hours.

Then, the bamboo pieces are took out from the solution. And, the bamboo pieces are drained and dried.

Next, bamboo fibers are obtained from the dried bamboo pieces. In some embodiments, a recarding machine may be used to scrape the bamboo pieces to make small fibers. Alternatively or Additionally, a pair or pairs of rollers may be used to crush the bamboo pieces to make them thinner, and a defibrating machine may be used to defibrate the crushed thin bamboo pieces to get fine and long fibers. In the same manner as strip processing of metal plates, each of the pairs of the rollers may be spaced with a different gap width, and they may be arranged in descending order of the gap widths. The rollers may have grooves with different shapes.

Then, the obtained bamboo fibers are screened to uniform their lengths and thickness. In some embodiments, the screening may be performed by eliminating nonstandard bamboo fibers, such as with lengths under 15 mm, with lengths over 70 mm, with average diameters under 0.07 mm, and with average diameters over 0.1 mm. The remaining bamboo fiber may further be dried.

Finally, dry distillation treatment is applied to the bamboo fibers. The dry distillation may be performed under 5.5 atmospheric pressures and 156° C. Alternatively, steam explosion treatment may be applied to the bamboo fibers.

### Manufacturing Blend Yarn

As shown in FIG. 2, cotton fibers are firstly provided, as well as the manufactured bamboo fiber. The cotton fibers may have lengths of about 40 mm. Alternatively, silk fiber may be provided. The silk fiber may be cut to have about 40 mm lengths.

Next, a mixing and blowing machine is used to mixing and blowing the provided cotton fibers to form a lap (1), which has a sheet shape as shown in FIGS. 3A and 3B, and which includes a large number of randomly entangled cotton fibers (3). This eliminates dust adhered with the cotton fibers. Different types of cotton fiber may be mixed. This restrains ununiformity of quality. The lap may be wound around a roller.

Then, the cotton fiber lap is mixed with the bamboo fibers to make mixed fiber. The blend ratio may be arbitrary. Proportion of the bamboo fibers over 50% facilitates to exert excellent effect of bamboo fiber. In contrast, lower ratio of the bamboo fiber makes the mixing and spinning easier. However, a ratio of the bamboo fiber is preferable to be a few % or more, in order to keep excellent properties derived from bamboo.

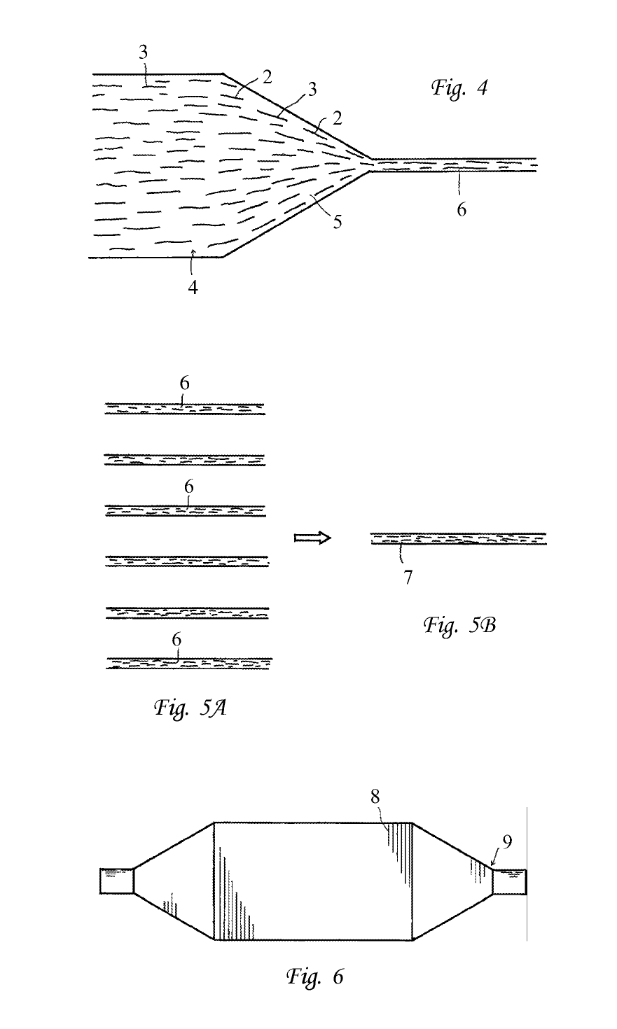

Next, a carding machine is used to comb the mixed fiber to form a sliver. This makes the mixed fiber separated to each of the fibers, and arranged parallelly. Also, small dust and short fibers are removed. Remaining long fibers, which include a large number of bamboo fibers (2) and cotton fibers (3) as shown in FIG. 4, are shaped into a thin sheet (4), which is converged to form a converged sheet (5) with a triangle shape, which is further converged to form a sliver (6) with a string shape.

As shown in FIGS. 5A and 5B, a drawing machine is used to double 6 or 8 strings of the slivers (6) and draft them to increase their lengths by 6 or 8 times, to form one drawn sliver (7) with a string shape. This makes the fibers straight, and eliminates unevenness of thickness to make the drawn sliver uniform. Also, short fibers are removed. A plurality of the drawn sliver may be drawn to form one further drawn sliver. The drawing step may be repeated 2 times or more.

Then, a roving machine is used to draft and twist the drawn sliver to form a rove. This makes the rove sufficiently thin to make blend yarn. The rove (8) may be wound around a bobbin (9) as shown in FIG. 6.

Next, the rove is further drafted and twisted to form a blend yarn, which is an end product. The twist of the blend yarn may be between 150 and 3000 turns per meter. The blend yarn may be immersed in and thereby coated with paste of arum root. This significantly enhances its fineness, and it can be used for making beautiful fabric or knitting. The blend yarn may be wound around a bobbin.

Finally, plural strings of the blend yarn are wound together to make one large package. The package may be shaped into a cone.

The blend yarn manufactured in this manner has about twice the strength of yarn made of only cotton fiber. Also, it has an adsorbing effect of formaldehyde or the like, a deodorizing effect, a soundproof effect, and an antibacterial effect against Staphylococcus aureus or the like. These effects are remarkable, and scarcely decreased even when laundered. The blend yarn is suitable to be used in products, especially required to have antioxidative effect, antibacterial effect, and/or deodorizing effect.

When the blend ratio of the bamboo fiber to the cotton fiber is 55:45, the blend yarn is suitable to be used for business shirts or jeans. This can be achieved by using cotton fiber with cotton count of 12, i.e., about 50 tex. When the blend ratio is 30:70, it is suitable to be used for socks or towels. This can be achieved by cotton fiber having cotton count of 20, i.e., about 300 tex. Using cotton fiber with cotton count of 5, i.e., about 120 tex, enables to make blend yarn in which the bamboo fiber is more than the cotton fiber and which is suitable to be used for shop curtains or carpet rags.

The manufacturing method in this manner is suitable to mass production. Also, its environmental load is very small. Thus, the blend yarn can be manufactured with low-cost.

The above described embodiments are examples to make it easier to understand the present invention. The present invention is not limited to the example, and includes any modified, altered, added, or removed variations, without departing from the scope of the claims attached herewith. This can be easily understood by persons skilled in the art.

### REFERENCE SIGNS LIST

1: lap; 2: bamboo fiber; 3: cotton fiber; 4: sheet; 5: converged sheet; 6: sliver; 7: drawn sliver; 8: rove; and 9: bobbin.

1. A method for manufacturing blend yarn with bamboo fiber, the method comprising:
immersing bamboo in alkali solution;
drying the bamboo took out from the alkali solution;
obtaining bamboo fiber from the dried bamboo;
performing a heat and pressure treatment over the obtained bamboo fiber; and
mixing and spinning the treated bamboo fiber with second fiber to form blend yarn, the second fiber being not bamboo fiber.

2. The method of claim 1, wherein the heat and pressure treatment is dry distillation treatment.

3. The method of claim 1, wherein the heat and pressure treatment is steam explosion treatment.

4. The method of claim 1, wherein the heat and pressure treatment is performed under a pressure between five and six atmospheric pressures.

5. The method of claim 1, wherein the heat and pressure treatment is performed under a temperature between 140 and 200 degrees Celsius.

6. The method of claim 1, wherein the heat and pressure treatment is performed under a temperature between 150 and 160 degrees Celsius.

7. The method of claim 1, wherein the heat and pressure treatment is performed during a period between three and ten minutes.

8. The method of claim 1, wherein the bamboo immersed in the alkali solution is not washed before the drying.

9. The method of claim 1, wherein the alkali solution is sodium hydroxide aqueous solution with concentration between one and six weight percent.

10. The method of claim 1, wherein the alkali solution is sodium hydroxide aqueous solution with concentration between one and three weight percent.

11. The method of claim 1, wherein the bamboo is immersed for a period between 24 and 48 hours.

12. The method of claim 1, wherein the bamboo is immersed for substantially 36 hours.

13. The method of claim 1, wherein
bamboo surface is not eliminated from the bamboo before the immersing, and
the blend yarn includes bamboo fiber derived from the bamboo surface.

14. The method of claim 1, wherein a bamboo joint is eliminated from the bamboo before the immersing.

15. The method of claim 1, wherein the bamboo is within the first year of growing.

16. The method of claim 1, wherein the bamboo fiber is obtained by recarding the dried bamboo.

17. The method of claim 1, wherein the bamboo fiber spun with the second fiber has a length between 15 and 70 millimeters.

18. The method of claim 1, wherein the bamboo fiber spun with the second fiber has an average diameter of 0.2 millimeter or smaller.

19. The method of claim 1, wherein the second fiber has a length of substantially 40 millimeters.

20. Blend yarn with bamboo fiber, the blend yarn manufactured by the method of claim 1.
